(19) United States
(12) Patent Application Publication
(10) Pub. No.: US 2025/0343596 A1
(43) Pub. Date: Nov. 6, 2025

(54) Non-Interrupted Remote Device Backup to a Cloud Platform

(71) Applicant: Dell Products L.P., Round Rock, TX (US)

(72) Inventors: Tomer Shachar, Beer-Sheva (IL); Yevgeni Gehtman, Modi'in (IL); Arieh Don, Newton, MA (US)

(21) Appl. No.: 18/656,162

(22) Filed: May 6, 2024

(51) Int. Cl. H04B 7/185; H04B 10/112; H04W 76/10; H04W 84/12

(52) U.S. Cl. CPC H04B 7/18504; H04B 10/112; H04W 76/10; H04W 84/12

(57) ABSTRACT

A system can physically position the system substantially above a device, wherein the device is configured to emit light-based communications substantially vertically, and wherein the device omits internet connectivity. The system can attempt to establish a light-based communications channel with the device to produce a result. The system can, based on the result indicating success in establishing the light-based communications channel with the device, receive data from the device via the light-based communications channel. The system can, based on the result indicating failure in establishing the light-based communications channel with the device, establish a radiofrequency-based communications channel with the device, and receive the data from the device via the radiofrequency-based communications channel. The system can, after receiving the data, physically move the system to a location where the system is configured to establish a network connection. The system can back up the data via the network connection.

### BACKGROUND

Data can be transferred via wireless protocols.

### SUMMARY

The following presents a simplified summary of the disclosed subject matter in order to provide a basic understanding of some of the various embodiments. This summary is not an extensive overview of the various embodiments. It is intended neither to identify key or critical elements of the various embodiments nor to delineate the scope of the various embodiments. Its sole purpose is to present some concepts of the disclosure in a streamlined form as a prelude to the more detailed description that is presented later.

An example system can operate as follows. The system can physically position the system, by the system, substantially above a device, wherein the device is configured to emit light-based communications substantially vertically, and wherein the device omits internet connectivity. The system can attempt to establish a light-based communications channel with the device to produce a result. The system can, based on the result indicating success in establishing the light-based communications channel with the device, receive data from the device via the light-based communications channel. The system can, based on the result indicating failure in establishing the light-based communications channel with the device, establish a radiofrequency-based communications channel with the device, and receive the data from the device via the radiofrequency-based communications channel. The system can, after receiving the data, physically move the system, by the system, to a location where the system is configured to establish a network connection. The system can back up the data to a storage device via the network connection.

An example method can comprise physically positioning a drone, by the drone comprising at least one processor, substantially above a device, wherein the device is configured to emit light-based communications substantially vertically, and wherein the device omits internet connectivity. The method can further comprise, where establishing a light-based communications channel with the device is successful, receiving, by the drone, data from the device via the light-based communications channel. The method can further comprise, where establishing the light-based communications channel with the device is unsuccessful, receiving, by the drone, the data from the device via a radiofrequency-based communications channel. The method can further comprise, after receiving the data, physically moving the drone, by the drone, to a location where the drone is configured to establish a network connection. The method can further comprise backing up, by the drone, the data to a storage device via the network connection.

An example non-transitory computer-readable medium can comprise instructions that, in response to execution, cause a system comprising a processor to perform operations. These operations can comprise, in response to establishing a light-based communications channel with a device being determined to be successful, receiving data from the device via the light-based communications channel. These operations can further comprise, in response to establishing the light-based communications channel with the device being determined to be unsuccessful, receiving the data from the device via a radiofrequency-based communications channel. These operations can further comprise, after receiving the data, physically moving the system to a location where the system has been determined to be able to establish a network connection. These operations can further comprise backing up the data to computer storage via the network connection.

### BRIEF DESCRIPTION OF THE DRAWINGS

Numerous embodiments, objects, and advantages of the present embodiments will be apparent upon consideration of the following detailed description, taken in conjunction with the accompanying drawings, in which like reference characters refer to like parts throughout, and in which:

FIG. 1 illustrates an example system architecture that can facilitate non-interrupted remote device backup to a cloud platform, in accordance with an embodiment of this disclosure;

FIG. 2 illustrates an example process flow that can facilitate non-interrupted remote device backup to a cloud platform, in accordance with an embodiment of this disclosure;

FIG. 3 illustrates an example path of a data collector drone that can facilitate non-interrupted remote device backup to a cloud platform, in accordance with an embodiment of this disclosure;

FIG. 4 illustrates an example of establishing a connection that can facilitate non-interrupted remote device backup to a cloud platform, in accordance with an embodiment of this disclosure;

FIG. 5 illustrates an example process flow that can facilitate non-interrupted remote device backup to a cloud platform, in accordance with an embodiment of this disclosure;

FIG. 6 illustrates another example process flow that can facilitate non-interrupted remote device backup to a cloud platform, in accordance with an embodiment of this disclosure;

FIG. 7 illustrates another example process flow that can facilitate non-interrupted remote device backup to a cloud platform, in accordance with an embodiment of this disclosure;

FIG. 8 illustrates another example process flow that can facilitate non-interrupted remote device backup to a cloud platform, in accordance with an embodiment of this disclosure;

FIG. 9 illustrates another example process flow that can facilitate non-interrupted remote device backup to a cloud platform, in accordance with an embodiment of this disclosure;

FIG. 10 illustrates another example process flow that can facilitate non-interrupted remote device backup to a cloud platform, in accordance with an embodiment of this disclosure;

FIG. 11 illustrates an example block diagram of a computer operable to execute an embodiment of this disclosure.

### DETAILED DESCRIPTION

### Overview

Remotely-located devices can be located where network infrastructure does not exist. It can be that data of these remotely-located devices' data is to be backed up (e.g., an Internet-of-Things (IoT) device, an operational technology (OT) device, a far edge device).

The present techniques can be implemented to facilitate transmission of data on scheduled-bases and in high bandwidth to keep the devices operational and remove an impact of the devices' data being unavailable.

A benefit of a wireless communication technology that uses light to transmit data (Li-Fi) is that can be used to transmit data at very high speeds.

A downside of Li-Fi can be that it is based on a wide light-spectrum (visible light, ultraviolet, and infrared).

Hence, for continuous communication, it can be that Li-Fi communication requires a clear line of communication between the transmitter and the receiver. Otherwise, it can be that the transmission cannot be transmitted directly due to topography constraints (e.g., mountains) or objects (e.g., buildings or trees).

The present techniques can be implemented to address these problems with an aeronautic-based solution is required. Where there is not a clear line of communication, there can be a secondary communication technique for ongoing and non-disruptive operation of devices that are communicating.

A device can comprise a Li-Fi transmitter, where the transmitter is positioned vertically (for a prevention of physical interference/constraints).

At a fixed cadence (which can be defined by a user), a drop that contains a Li-Fi receiver can fly over the device, where the drone serves as a data collector. Once the drone reaches its target, it can circle the target in an attempt to establish a stable Li-Fi connection.

If a stable Li-Fi connection cannot be established, the drone can establish communication via a wireless (Wi-Fi) communications protocol (which can communicate through various physical solid objects).

This approach can reduce an availability impact to devices that are served according to the present techniques.

When data has been collected, the can fly back to a nearest point where a stable network infrastructure exists. When the drone arrives at a charging station, it can begin transmitting the collected data to a cloud communications platform (or a computer, where a cloud communications platform, or a cloud platform, can generally comprise one or more computers that offer computer storage services).

The present techniques can be implemented to facilitate backing up remotely located devices' data to a cloud computing platform via a Li-Fi and Wi-Fi protocol switcher to establish non-interruptive communication. This backup can be performed even without an existing network infrastructure.

### Example Architectures, Etc.

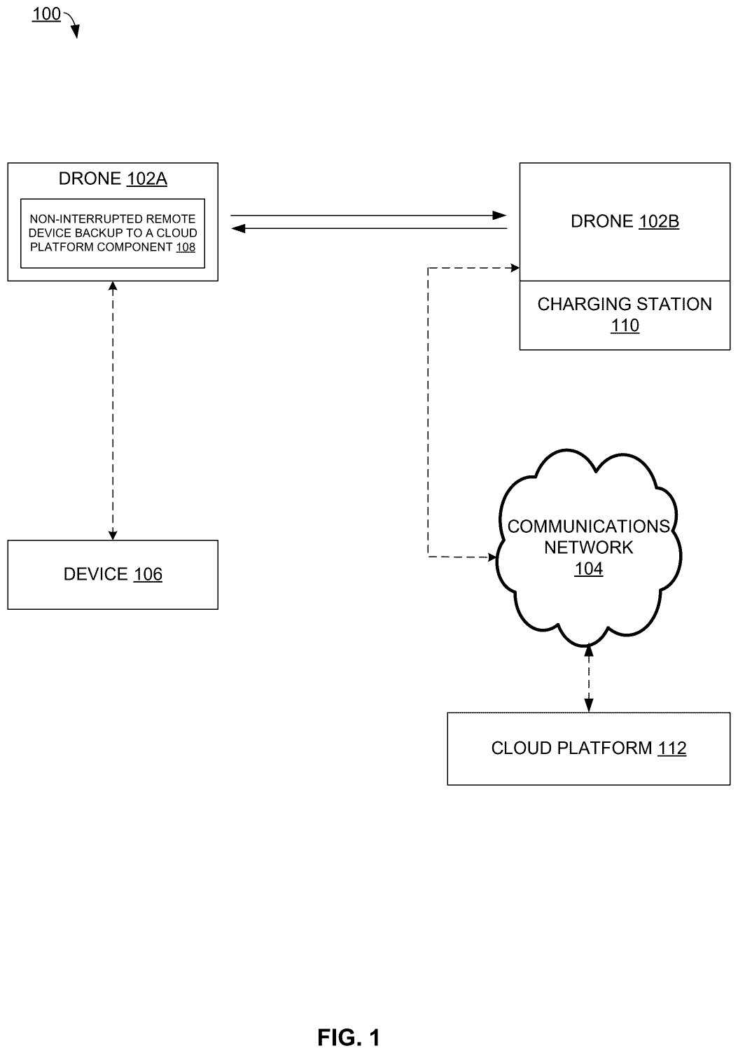

FIG. 1 illustrates an example system architecture 100 that can facilitate non-interrupted remote device backup to a cloud platform, in accordance with an embodiment of this disclosure.

System architecture 100 comprises drone 102A, drone 102B, communications network 104, device 106, non-interrupted remote device backup to a cloud platform component 108, charging station 110, and cloud platform 112.

System architecture 100 presents one logical example of implementing the present techniques, and it can be appreciated that there can be other example architectures.

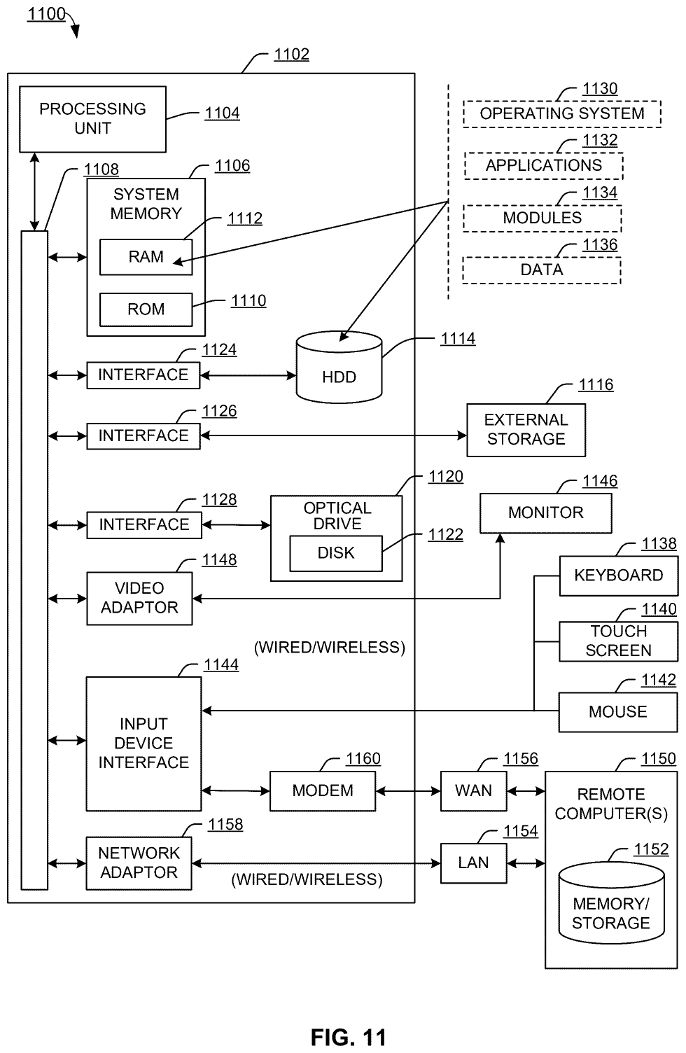

Each of drone 102A, drone 102B, device 106, and/or cloud platform 112 can be implemented with part(s) of computing environment 1100 of FIG. 11. Communications network 104 can comprise a computer communications network, such as the Internet, or an intranet.

Device 106 can be a computing device that collects data (e.g., weather data from sensors), but lacks a durable network connection to upload that data to cloud platform 112. Drone 102A can travel to device 106, and establish a communications link with device 106. Drone 102A can attempt to establish a Li-Fi link, and where that is not possible, instead establish a Wi-Fi link. After collecting all new data from device 106 (or collecting data according to a criterion, such as an amount of data collected, an amount of time elapsed, or an amount of battery life left in drone 102A), drone 102A can travel toward charging and network infrastructure. This is illustrated with drone 102B.

Drone 102B can recharge at charging station 110. At this physical location, there can be sufficient network infrastructure (e.g., communications network 104) to upload data gathered from device 106 to cloud platform 112. In some examples, such as described herein, drone 102B can upload data at a physical location that is different from charging station 110—that is charging and uploading can be performed separately from each other.

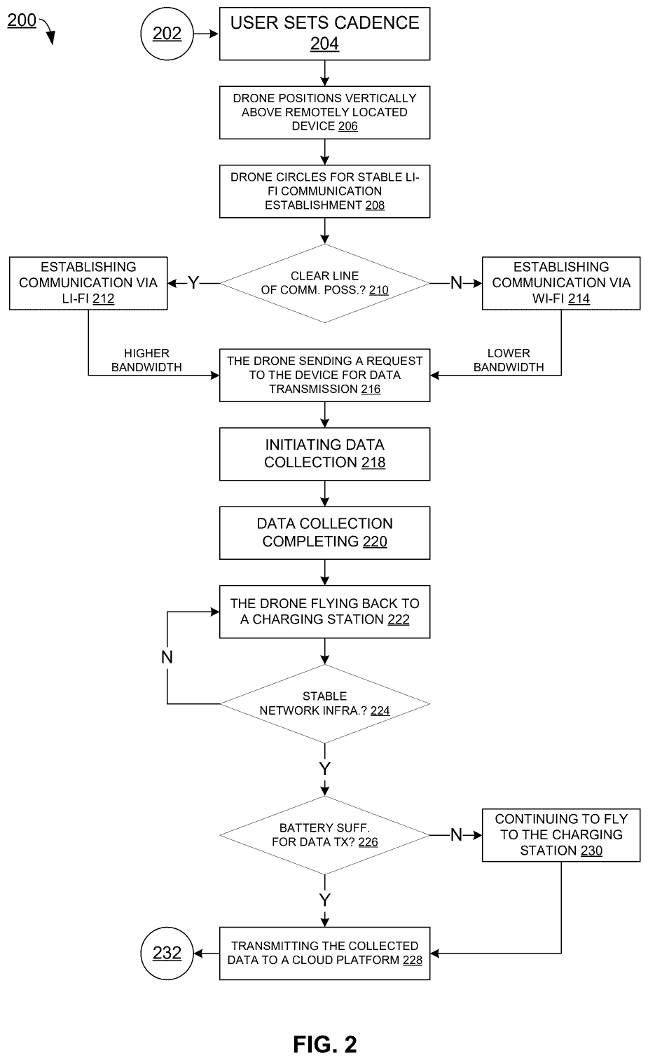

In some examples, non-interrupted remote device backup to a cloud platform component 108 can implement part(s) of the process flows of FIGS. 2 and/or 5-10 to implement non-interrupted remote device backup to a cloud platform.

It can be appreciated that system architecture 100 is one example system architecture for non-interrupted remote device backup to a cloud platform, and that there can be other system architectures that facilitate non-interrupted remote device backup to a cloud platform.

FIG. 2 illustrates an example process flow 200 that can facilitate non-interrupted remote device backup to a cloud platform, in accordance with an embodiment of this disclosure. In some examples, one or more embodiments of process flow 200 can be implemented by non-interrupted remote device backup to a cloud platform component 108 of FIG. 1, or computing environment 1100 of FIG. 11.

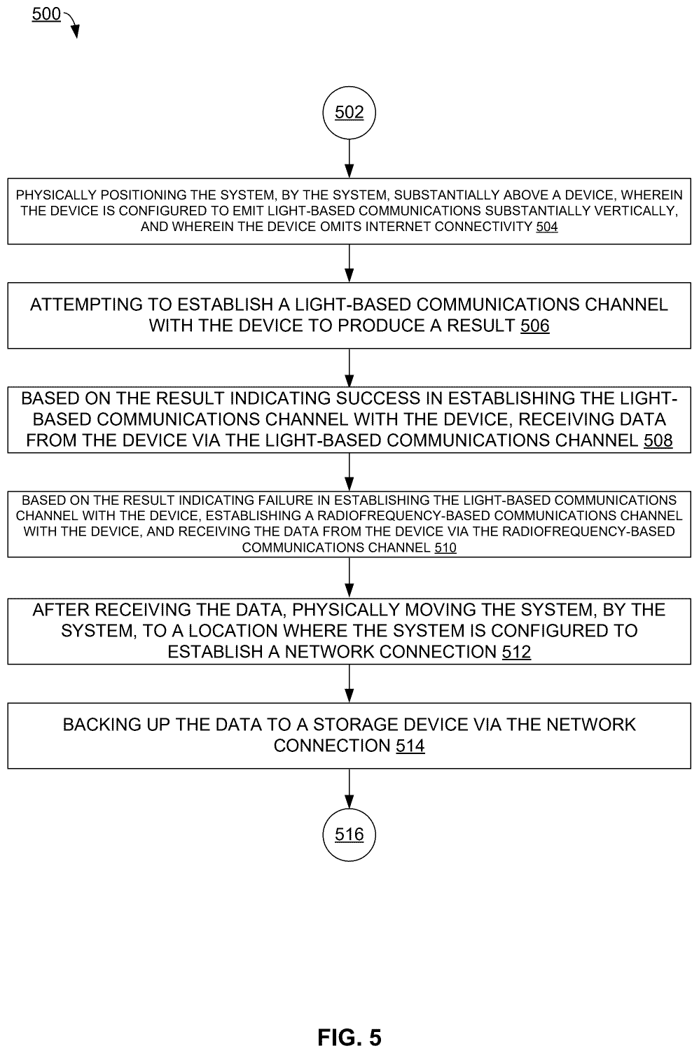

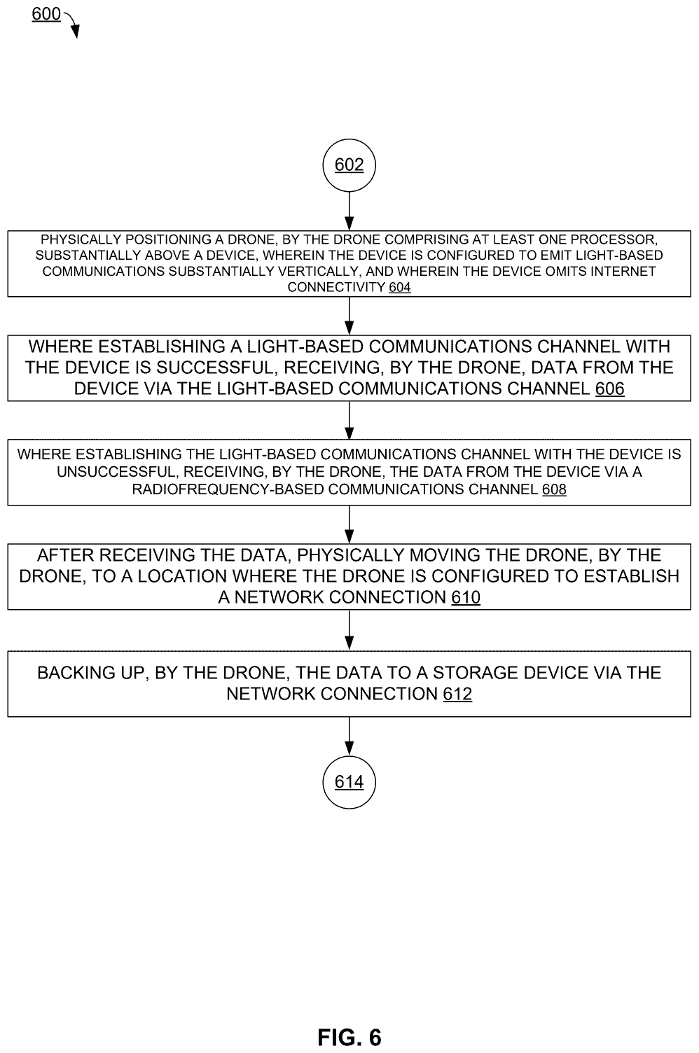

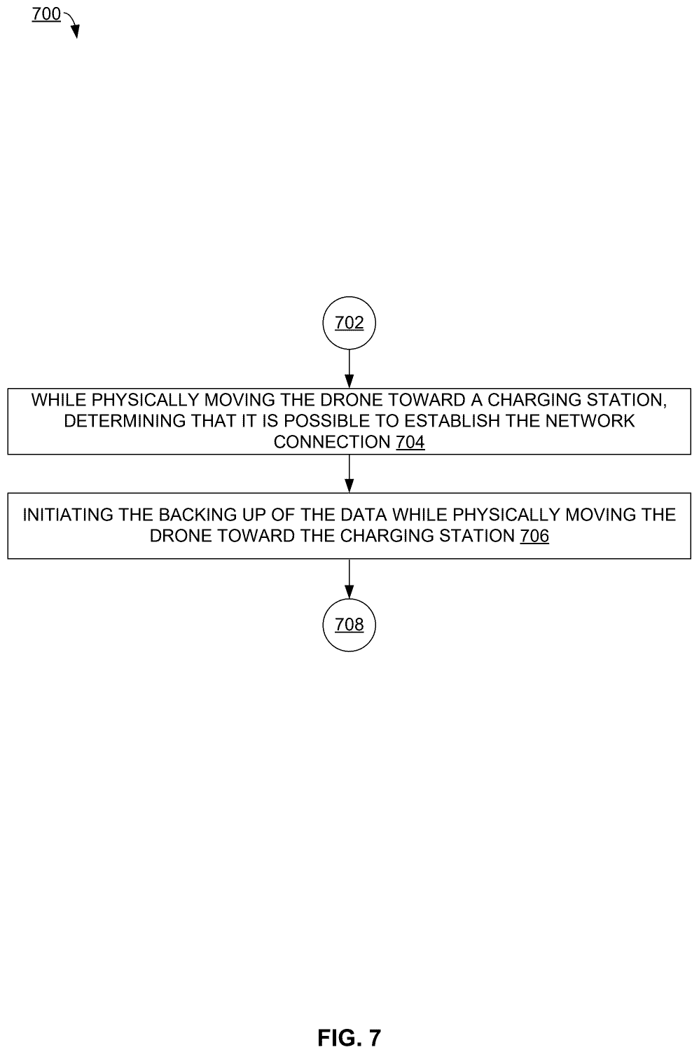

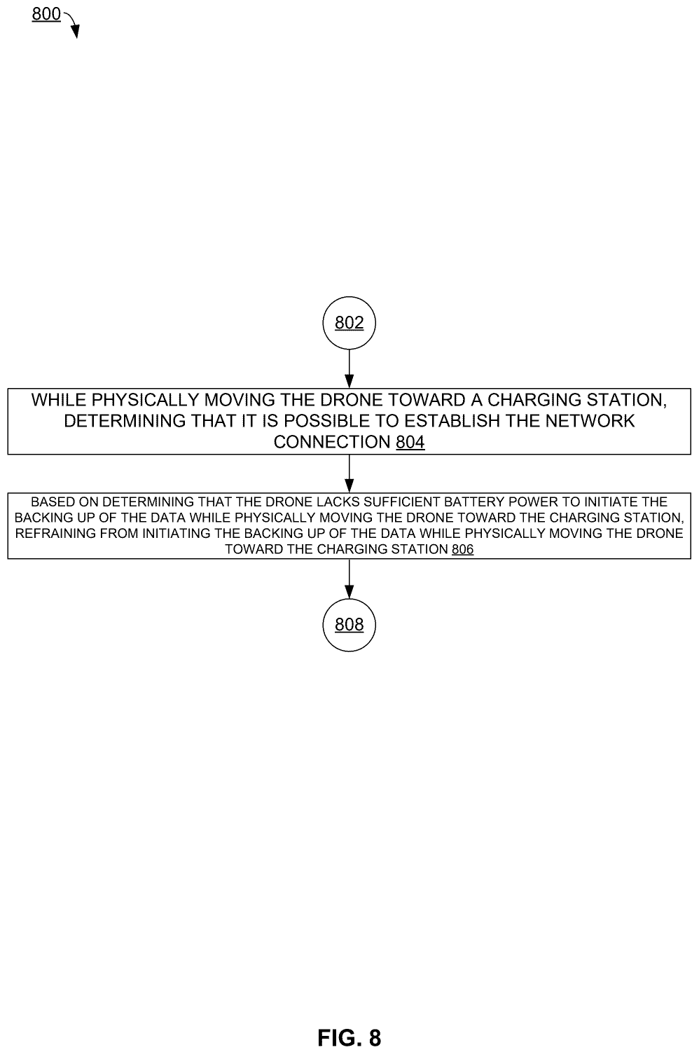

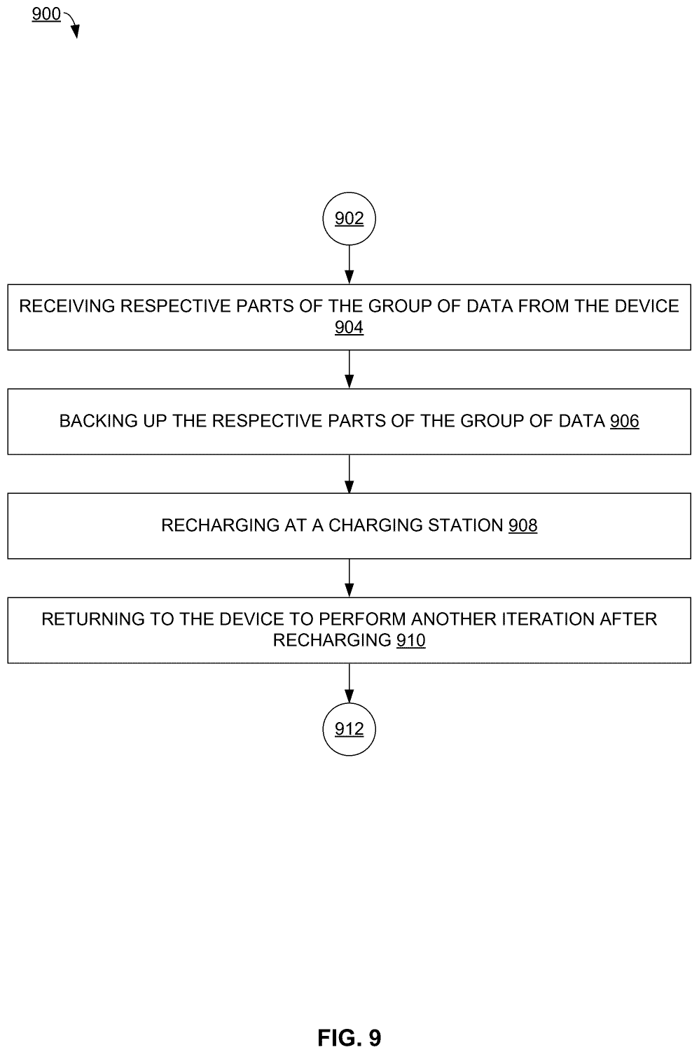

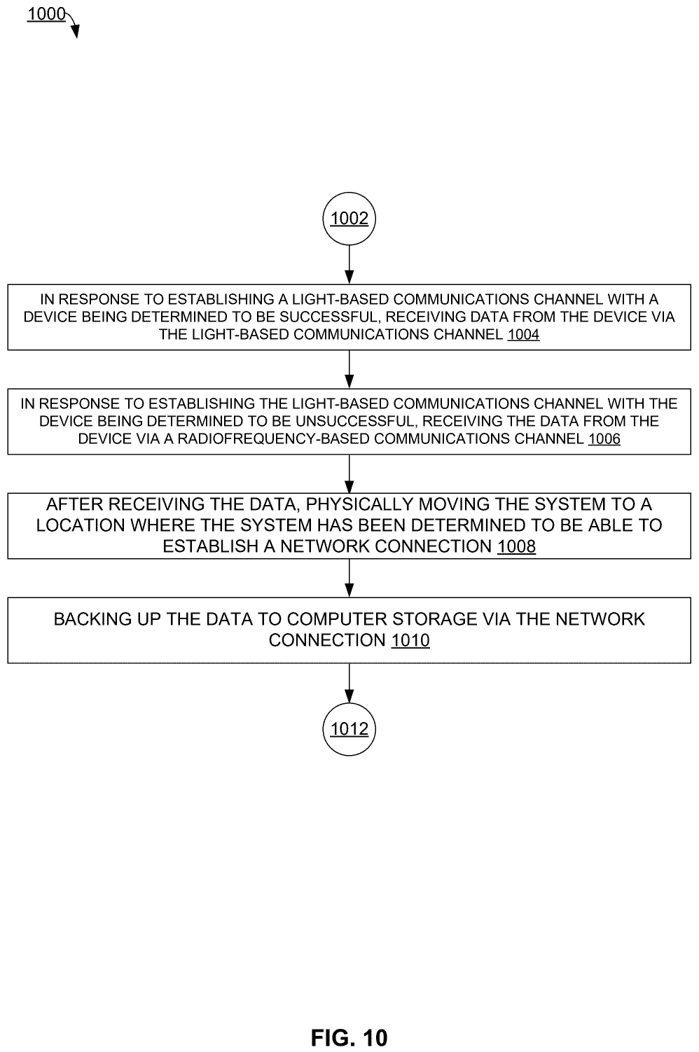

It can be appreciated that the operating procedures of process flow 200 are example operating procedures, and that there can be embodiments that implement more or fewer operating procedures than are depicted, or that implement the depicted operating procedures in a different order than as depicted. In some examples, process flow 200 can be implemented in conjunction with one or more embodiments of one or more of process flow 500 of FIG. 5, process flow 600 of FIG. 6, process flow 700 of FIG. 7, process flow 800 of FIG. 8, process flow 900 or FIG. 9, and/or process flow 1000 of FIG. 10.

Process flow 200 begins with 202, and moves to operation 204.

Operation 204 depicts user sets cadence. This can be a cadence with which a drone backs up data from a device.

After operation 204, process flow 200 moves to operation 206.

Operation 206 depicts drone positions vertically above remotely located device.

After operation 206, process flow 200 moves to operation 208.

Operation 208 depicts drone circles for stable Li-Fi communication establishment.

After operation 208, process flow 200 moves to operation 210.

Operation 210 depicts determining whether a clear line of communication is possible.

Where it is determined in operation 210 that a clear line of communication is possible, process flow 200 moves to operation 212. Instead, where it is determined in operation 210 that a clear line of communication is not possible, process flow 200 moves to operation 214.

Operation 212 is reached from operation 210 where it is determined that a clear line of communication is possible. Operation 212 depicts establishing communication via Li-Fi.

After operation 212, process flow 200 moves to operation 216.

Operation 214 is reached from operation 210 where it is determined that a clear line of communication is not possible. Operation 214 depicts establishing communication via Wi-Fi.

After operation 214, process flow 200 moves to operation 216.

Operation 216 is reached from operation 212 or from operation 214. Operation 216 depicts the drone sending a request to the device for data transmission.

After operation 216, process flow 200 moves to operation 218.

Operation 218 depicts initiating data collection.

After operation 218, process flow 200 moves to operation 220.

Operation 220 depicts data collection having completed.

After operation 220, process flow 200 moves to operation 222.

Operation 222 is reached from operation 220, or from operation 224 where it is determined that stable network infrastructure does not exist. Operation 222 depicts the drone flying back to a charging station.

After operation 222, process flow 200 moves to operation 224.

Operation 224 depicts determining whether stable network infrastructure exists.

Where it is determined in operation 224 that stable network infrastructure exists, process flow 200 moves to operation 226. Instead, where it is determined in operation 224 that stable network infrastructure does not exist, process flow 200 returns to operation 222.

Operation 226 is reached from operation 224 where it is determined that stable network infrastructure exists. Operation 226 depicts determining whether battery is sufficient for data transmission.

Where it is determined in operation 226 that battery is sufficient for data transmission, process flow 200 moves to operation 228. Instead, where it is determined in operation 226 that battery is not sufficient for data transmission, process flow 200 moves to operation 230.

Operation 228 is reached from operation 226 where it is determined that battery is sufficient for data transmission. Operation 228 depicts transmitting the collected data to a cloud platform.

After operation 228, process flow 200 moves to 232, where process flow 200 ends.

Operation 230 is reached from operation 226 where it is determined that battery is not sufficient for data transmission. Operation 230 depicts continuing to fly to the charging station.

After operation 230, process flow 200 moves to operation 228.

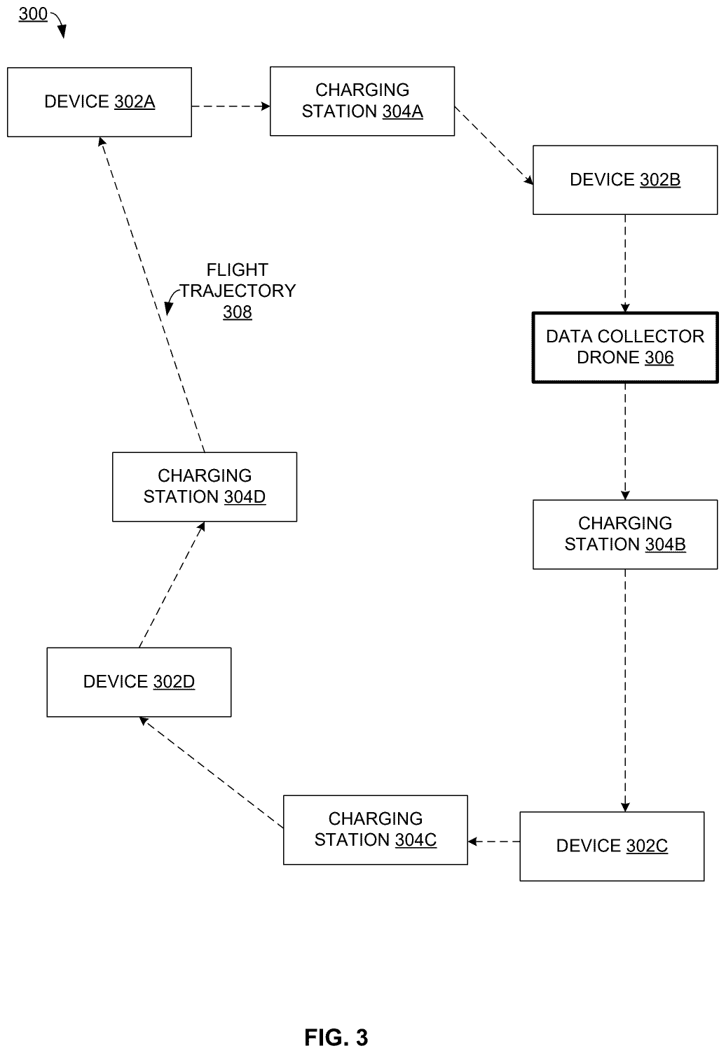

FIG. 3 illustrates an example path 300 of a data collector drone that can facilitate non-interrupted remote device backup to a cloud platform, in accordance with an embodiment of this disclosure. In some examples, parts of path 300 can be used by part(s) of system architecture 100 of FIG. 1 to facilitate non-interrupted remote device backup to a cloud platform.

Path 300 comprises device 302A, device 302B, device 302C, device 302D, charging station 304A, charging station 304B, charging station 304C, charging station 304D, data collector drone 306, and flight trajectory 308.

According to the present techniques, data collector drone 306 can fly along flight trajectory 308, collecting data from device 302A, device 302B, device 302C, device 302D (and uploading it to the cloud), and recharging at charging station 304A, charging station 304B, charging station 304C, at charging station 304D.

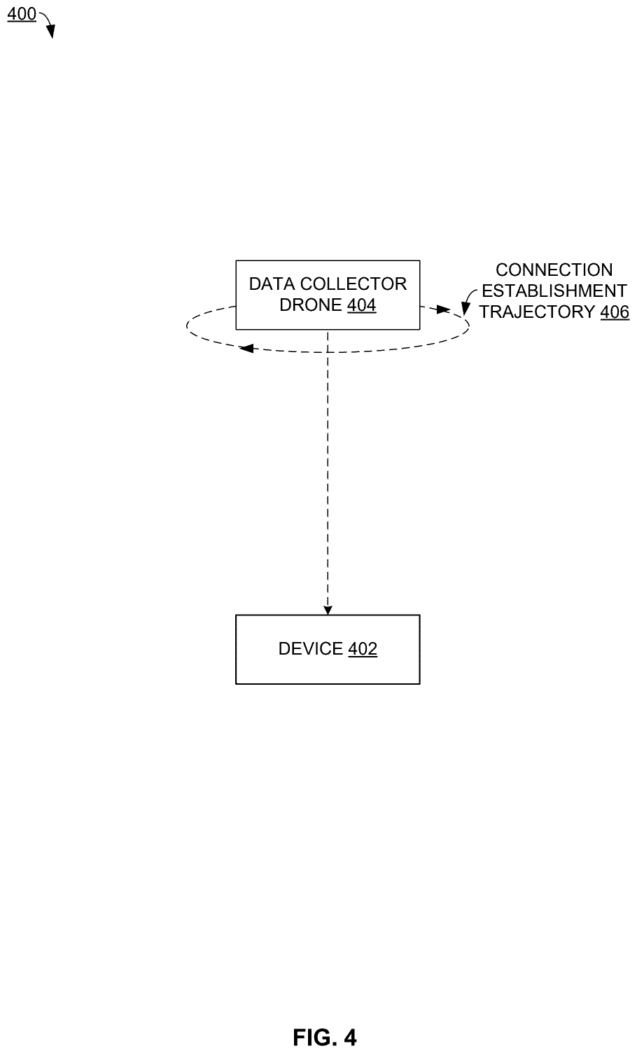

FIG. 4 illustrates an example 400 of establishing a connection that can facilitate non-interrupted remote device backup to a cloud platform, in accordance with an embodiment of this disclosure. In some examples, parts of example 300 can be used by part(s) of system architecture 100 of FIG. 1 to facilitate non-interrupted remote device backup to a cloud platform.

System architecture 400 comprises device 402, data collector drone 404, and connection establishment trajectory 406.

When data collector drone 404 arrives at a device (e.g., device 402), data collector drone 404 can move in an area (e.g., a circle) above the device in an attempt to establish a Li-Fi connection. This can be because there can be a line-of-sight blockage between data collector drone 404 and the device from certain angles, but not others. And the blockages can change over time (e.g., plants growing).

### Example Process Flows

FIG. 5 illustrates an example process flow 500 that can facilitate non-interrupted remote device backup to a cloud platform, in accordance with an embodiment of this disclosure. In some examples, one or more embodiments of process flow 500 can be implemented by non-interrupted remote device backup to a cloud platform component 108 of FIG. 1, or computing environment 1100 of FIG. 11.

It can be appreciated that the operating procedures of process flow 500 are example operating procedures, and that there can be embodiments that implement more or fewer operating procedures than are depicted, or that implement the depicted operating procedures in a different order than as depicted. In some examples, process flow 500 can be implemented in conjunction with one or more embodiments of one or more of process flow 200 of FIG. 2, process flow 600 of FIG. 6, process flow 700 of FIG. 7, process flow 800 of FIG. 8, process flow 900 or FIG. 9, and/or process flow 1000 of FIG. 10.

Process flow 500 begins with 502, and moves to operation 504.

Operation 504 depicts physically positioning the system, by the system, substantially above a device, wherein the device is configured to emit light-based communications substantially vertically, and wherein the device omits internet connectivity. Using the example of FIG. 1, this can comprise drone 102A traveling to device 106.

In some examples, the system comprises an aerial drone.

In some examples, physically positioning the system substantially above the device comprises establishing a line of sight between a first light-based communications component of the device and a second light-based communications component of the system.

After operation 504, process flow 500 moves to operation 506.

Operation 506 depicts attempting to establish a light-based communications channel with the device to produce a result. Using the example of FIG. 1, this can comprise drone 102A attempting to establish a Li-Fi connection with device 106.

In some examples, the light-based communications channel comprises a Li-Fi connection.

In some examples, attempting to establish the light-based communications channel with the device comprises moving the system, by the system, while attempting to establish the light-based communications channel. This can be implemented in a similar manner as described with respect to FIG. 4.

After operation 506, process flow 500 moves to operation 508.

Operation 508 depicts, based on the result indicating success in establishing the light-based communications channel with the device, receiving data from the device via the light-based communications channel. Using the example of FIG. 1, this can comprise drone 102A uploading data from device 106 via a Li-Fi channel.

After operation 508, process flow 500 moves to operation 510.

Operation 510 depicts, based on the result indicating failure in establishing the light-based communications channel with the device, establishing a radiofrequency-based communications channel with the device, and receiving the data from the device via the radiofrequency-based communications channel. Using the example of FIG. 1, this can comprise drone 102A attempting to establish a WiFi connection with device 106.

In some examples, the radiofrequency-based communications channel comprises a Wi-Fi connection.

In some examples, receiving the data from the device via the light-based communications channel, or receiving the data from the device via the radiofrequency-based communications channel, is performed based on sending a request to the device for data transfer. That is, a drone can initiate data transfer with the device.

After operation 510, process flow 500 moves to operation 512.

Operation 512 depicts, after receiving the data, physically moving the system, by the system, to a location where the system is configured to establish a network connection. Using the example of FIG. 1, this can comprise drone 102A toward where drone 102B is positioned.

After operation 512, process flow 500 moves to operation 514.

Operation 514 depicts backing up the data to a storage device via the network connection. Using the example of FIG. 1, this can comprise drone 102B uploading data to cloud platform 112 via communications network 104.

After operation 514, process flow 500 moves to 516, where process flow 500 ends.

FIG. 6 illustrates an example process flow 600 that can facilitate non-interrupted remote device backup to a cloud platform, in accordance with an embodiment of this disclosure. In some examples, one or more embodiments of process flow 600 can be implemented by non-interrupted remote device backup to a cloud platform component 108 of FIG. 1, or computing environment 1100 of FIG. 11.

It can be appreciated that the operating procedures of process flow 600 are example operating procedures, and that there can be embodiments that implement more or fewer operating procedures than are depicted, or that implement the depicted operating procedures in a different order than as depicted. In some examples, process flow 600 can be implemented in conjunction with one or more embodiments of one or more of process flow 200 of FIG. 2, process flow 500 of FIG. 5, process flow 700 of FIG. 7, process flow 800 of FIG. 8, process flow 900 or FIG. 9, and/or process flow 1000 of FIG. 10.

Process flow 600 begins with 602, and moves to operation 604.

Operation 604 depicts physically positioning a drone, by the drone comprising at least one processor, substantially above a device, wherein the device is configured to emit light-based communications substantially vertically, and wherein the device omits internet connectivity. In some examples, operation 604 can be implemented in a similar manner as operation 504 of FIG. 5.

After operation 604, process flow 600 moves to operation 606.

Operation 606 depicts, where establishing a light-based communications channel with the device is successful, receiving, by the drone, data from the device via the light-based communications channel. In some examples, operation 606 can be implemented in a similar manner as operations 506-508 of FIG. 5.

After operation 606, process flow 600 moves to operation 608.

Operation 608 depicts, where establishing the light-based communications channel with the device is unsuccessful, receiving, by the drone, the data from the device via a radiofrequency-based communications channel. In some examples, operation 608 can be implemented in a similar manner as operation 510 of FIG. 5.

After operation 608, process flow 600 moves to operation 610.

Operation 610 depicts, after receiving the data, physically moving the drone, by the drone, to a location where the drone is configured to establish a network connection. In some examples, operation 610 can be implemented in a similar manner as operation 512 of FIG. 5.

In some examples, the location where the drone is configured to establish the network connection comprises a charging station for the drone. That is, in some examples, a drone can travel to a charging station, and upload data while at the charging station.

After operation 610, process flow 600 moves to operation 612.

Operation 612 depicts backing up, by the drone, the data to a storage device via the network connection. In some examples, operation 612 can be implemented in a similar manner as operation 514 of FIG. 5.

In some examples, a cloud computing platform comprises the storage device. This can be similar to cloud platform 112 of FIG. 1.

After operation 612, process flow 600 moves to 614, where process flow 600 ends.

FIG. 7 illustrates an example process flow 700 that can facilitate non-interrupted remote device backup to a cloud platform, in accordance with an embodiment of this disclosure. In some examples, one or more embodiments of process flow 700 can be implemented by non-interrupted remote device backup to a cloud platform component 108 of FIG. 1, or computing environment 1100 of FIG. 11.

It can be appreciated that the operating procedures of process flow 700 are example operating procedures, and that there can be embodiments that implement more or fewer operating procedures than are depicted, or that implement the depicted operating procedures in a different order than as depicted. In some examples, process flow 700 can be implemented in conjunction with one or more embodiments of one or more of process flow 200 of FIG. 2, process flow 500 of FIG. 5, process flow 600 of FIG. 6, process flow 800 of FIG. 8, process flow 900 or FIG. 9, and/or process flow 1000 of FIG. 10.

Process flow 700 begins with 702, and moves to operation 704.

Operation 704 depicts, while physically moving the drone toward a charging station, determining that it is possible to establish the network connection. That is, it can be that a drone gets within network infrastructure range before it reaches a charging station.

After operation 704, process flow 700 moves to operation 706.

Operation 706 depicts initiating the backing up of the data while physically moving the drone toward the charging station. That is, it can be that the drone starts uploading data to a cloud platform while continuing to travel to a charging station.

After operation 706, process flow 700 moves to 708, where process flow 700 ends.

FIG. 8 illustrates an example process flow 800 that can facilitate non-interrupted remote device backup to a cloud platform, in accordance with an embodiment of this disclosure. In some examples, one or more embodiments of process flow 800 can be implemented by non-interrupted remote device backup to a cloud platform component 108 of FIG. 1, or computing environment 1100 of FIG. 11.

It can be appreciated that the operating procedures of process flow 800 are example operating procedures, and that there can be embodiments that implement more or fewer operating procedures than are depicted, or that implement the depicted operating procedures in a different order than as depicted. In some examples, process flow 800 can be implemented in conjunction with one or more embodiments of one or more of process flow 200 of FIG. 2, process flow 500 of FIG. 5, process flow 600 of FIG. 6, process flow 700 of FIG. 7, process flow 900 or FIG. 9, and/or process flow 1000 of FIG. 10.

Process flow 800 begins with 802, and moves to operation 804.

Operation 804 depicts, while physically moving the drone toward a charging station, determining that it is possible to establish the network connection. That is, it can be that a drone gets within network infrastructure range before it reaches a charging station.

After operation 804, process flow 800 moves to operation 806.

Operation 806 depicts, based on determining that the drone lacks sufficient battery power to initiate the backing up of the data while physically moving the drone toward the charging station, refraining from initiating the backing up of the data while physically moving the drone toward the charging station. That is, it can be that, even though the drone could start uploading data, due to battery considerations (e.g., having enough battery to travel to the charging station), the drone refrains from uploading data until it has reached charging infrastructure.

In some examples, operation 806 comprises, after arriving at the charging station, initiating the backing up of the data.

After operation 806, process flow 800 moves to 808, where process flow 800 ends.

FIG. 9 illustrates an example process flow 900 that can facilitate non-interrupted remote device backup to a cloud platform, in accordance with an embodiment of this disclosure. In some examples, one or more embodiments of process flow 900 can be implemented by non-interrupted remote device backup to a cloud platform component 108 of FIG. 1, or computing environment 1100 of FIG. 11.

It can be appreciated that the operating procedures of process flow 900 are example operating procedures, and that there can be embodiments that implement more or fewer operating procedures than are depicted, or that implement the depicted operating procedures in a different order than as depicted. In some examples, process flow 900 can be implemented in conjunction with one or more embodiments of one or more of process flow 200 of FIG. 2, process flow 500 of FIG. 5, process flow 600 of FIG. 6, process flow 700 of FIG. 7, process flow 800 or FIG. 8, and/or process flow 1000 of FIG. 10.

Process flow 900 begins with 902, and moves to operation 904.

Operation 904 depicts receiving respective parts of a group of data from the device. That is, data from a device can be backed up in parts, such as separate trips.

After operation 904, process flow 900 moves to operation 906.

Operation 906 depicts backing up the respective parts of the group of data.

After operation 906, process flow 900 moves to operation 908.

Operation 908 depicts recharging at a charging station. That is, in between backing up some data from a device, a drone can recharge.

After operation 908, process flow 900 moves to operation 910.

Operation 910 depicts returning to the device to perform another iteration after recharging.

In some examples, iterations of operations 904-910 can be performed to back up data from a device across multiple trips, where a drone lacks the ability to do it in one trip (e.g., due to battery or storage limitations).

After operation 910, process flow 900 moves to 912, where process flow 900 ends.

FIG. 10 illustrates an example process flow 1000 that can facilitate non-interrupted remote device backup to a cloud platform, in accordance with an embodiment of this disclosure. In some examples, one or more embodiments of process flow 1000 can be implemented by non-interrupted remote device backup to a cloud platform component 108 of FIG. 1, or computing environment 1100 of FIG. 11.

It can be appreciated that the operating procedures of process flow 1000 are example operating procedures, and that there can be embodiments that implement more or fewer operating procedures than are depicted, or that implement the depicted operating procedures in a different order than as depicted. In some examples, process flow 1000 can be implemented in conjunction with one or more embodiments of one or more of process flow 200 of FIG. 2, process flow 500 of FIG. 5, process flow 600 of FIG. 6, process flow 700 of FIG. 7, process flow 800 or FIG. 8, and/or process flow 900 of FIG. 9.

Process flow 1000 begins with 1002, and moves to operation 1004.

Operation 1004 depicts, in response to establishing a light-based communications channel with a device being determined to be successful, receiving data from the device via the light-based communications channel. In some examples, operation 1004 can be implemented in a similar manner as operations 506-508 of FIG. 5.

In some examples, operation 1004 comprises physically positioning the system substantially above the device before attempting to establish the light-based communications channel with the device.

In some examples, operation 1004 comprises, while receiving the data from the device via the light-based communications channel, determining that the light-based communications channel has become unavailable, and continuing to receive the data from the device via the radiofrequency-based communications channel. That is, a fallback to a Wi-Fi connection can be made where a Li-Fi connection is lost.

In some examples, operation 1004 comprises moving the device in a substantially circular motion while attempting to establish the light-based communications channel with the device. This can be implemented in a similar manner as described with respect to FIG. 4.

After operation 1004, process flow 1000 moves to operation 1006.

Operation 1006 depicts, in response to establishing the light-based communications channel with the device being determined to be unsuccessful, receiving the data from the device via a radiofrequency-based communications channel. In some examples, operation 1006 can be implemented in a similar manner as operation 510 of FIG. 5.

After operation 1006, process flow 1000 moves to operation 1008.

Operation 1008 depicts, after receiving the data, physically moving the system to a location where the system has been determined to be able to establish a network connection. In some examples, operation 1008 can be implemented in a similar manner as operation 512 of FIG. 5.

After operation 1008, process flow 1000 moves to operation 1010.

Operation 1010 depicts backing up the data to computer storage via the network connection. In some examples, operation 1010 can be implemented in a similar manner as operation 514 of FIG. 5.

In some examples, iterations of the receiving of the data, the physically moving of the system, and the backing up of the data are performed according to a schedule.

In some examples, the schedule is determined based on user input data. This can be implemented in a similar manner as operation 204 of FIG. 2.

After operation 1010, process flow 1000 moves to 1012, where process flow 1000 ends.

### Example Operating Environment

In order to provide additional context for various embodiments described herein, FIG. 11 and the following discussion are intended to provide a brief, general description of a suitable computing environment 1100 in which the various embodiments of the embodiment described herein can be implemented.

For example, parts of computing environment 1100 can be used to implement one or more embodiments of drone 102A, drone 102B, device 106, and/or cloud platform 112.

In some examples, computing environment 1100 can implement one or more embodiments of the process flows of FIGS. 2 and/or 5-10 to facilitate non-interrupted remote device backup to a cloud platform.

While the embodiments have been described above in the general context of computer-executable instructions that can run on one or more computers, those skilled in the art will recognize that the embodiments can be also implemented in combination with other program modules and/or as a combination of hardware and software.

Generally, program modules include routines, programs, components, data structures, etc., that perform particular tasks or implement particular abstract data types. Moreover, those skilled in the art will appreciate that the various methods can be practiced with other computer system configurations, including single-processor or multiprocessor computer systems, minicomputers, mainframe computers, Internet of Things (IoT) devices, distributed computing systems, as well as personal computers, hand-held computing devices, microprocessor-based or programmable consumer electronics, and the like, each of which can be operatively coupled to one or more associated devices.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically include a variety of media, which can include computer-readable storage media, machine-readable storage media, and/or communications media, which two terms are used herein differently from one another as follows. Computer-readable storage media or machine-readable storage media can be any available storage media that can be accessed by the computer and includes both volatile and nonvolatile media, removable and non-removable media. By way of example, and not limitation, computer-readable storage media or machine-readable storage media can be implemented in connection with any method or technology for storage of information such as computer-readable or machine-readable instructions, program modules, structured data or unstructured data.

Computer-readable storage media can include, but are not limited to, random access memory (RAM), read only memory (ROM), electrically erasable programmable read only memory (EEPROM), flash memory or other memory technology, compact disk read only memory (CD-ROM), digital versatile disk (DVD), Blu-ray disc (BD) or other optical disk storage, magnetic cassettes, magnetic tape, magnetic disk storage or other magnetic storage devices, solid state drives or other solid state storage devices, or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

With reference again to FIG. 11, the example environment 1100 for implementing various embodiments described herein includes a computer 1102, the computer 1102 including a processing unit 1104, a system memory 1106 and a system bus 1108. The system bus 1108 couples system components including, but not limited to, the system memory 1106 to the processing unit 1104. The processing unit 1104 can be any of various commercially available processors. Dual microprocessors and other multi-processor architectures can also be employed as the processing unit 1104.

The system bus 1108 can be any of several types of bus structure that can further interconnect to a memory bus (with or without a memory controller), a peripheral bus, and a local bus using any of a variety of commercially available bus architectures. The system memory 1106 includes ROM 1110 and RAM 1112. A basic input/output system (BIOS) can be stored in a nonvolatile storage such as ROM, erasable programmable read only memory (EPROM), EEPROM, which BIOS contains the basic routines that help to transfer information between elements within the computer 1102, such as during startup. The RAM 1112 can also include a high-speed RAM such as static RAM for caching data.

The computer 1102 further includes an internal hard disk drive (HDD) 1114 (e.g., EIDE, SATA), one or more external storage devices 1116 (e.g., a magnetic floppy disk drive (FDD) 1116, a memory stick or flash drive reader, a memory card reader, etc.) and an optical disk drive 1120 (e.g., which can read or write from a CD-ROM disc, a DVD, a BD, etc.). While the internal HDD 1114 is illustrated as located within the computer 1102, the internal HDD 1114 can also be configured for external use in a suitable chassis (not shown). Additionally, while not shown in environment 1100, a solid state drive (SSD) could be used in addition to, or in place of, an HDD 1114. The HDD 1114, external storage device(s) 1116 and optical disk drive 1120 can be connected to the system bus 1108 by an HDD interface 1124, an external storage interface 1126 and an optical drive interface 1128, respectively. The interface 1124 for external drive implementations can include at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 1102, the drives and storage media accommodate the storage of any data in a suitable digital format. Although the description of computer-readable storage media above refers to respective types of storage devices, it should be appreciated by those skilled in the art that other types of storage media which are readable by a computer, whether presently existing or developed in the future, could also be used in the example operating environment, and further, that any such storage media can contain computer-executable instructions for performing the methods described herein.

A number of program modules can be stored in the drives and RAM 1112, including an operating system 1130, one or more application programs 1132, other program modules 1134 and program data 1136. All or portions of the operating system, applications, modules, and/or data can also be cached in the RAM 1112. The systems and methods described herein can be implemented utilizing various commercially available operating systems or combinations of operating systems.

Computer 1102 can optionally comprise emulation technologies. For example, a hypervisor (not shown) or other intermediary can emulate a hardware environment for operating system 1130, and the emulated hardware can optionally be different from the hardware illustrated in FIG. 11. In such an embodiment, operating system 1130 can comprise one virtual machine (VM) of multiple VMs hosted at computer 1102. Furthermore, operating system 1130 can provide runtime environments, such as the Java runtime environment or the .NET framework, for applications 1132. Runtime environments are consistent execution environments that allow applications 1132 to run on any operating system that includes the runtime environment. Similarly, operating system 1130 can support containers, and applications 1132 can be in the form of containers, which are lightweight, standalone, executable packages of software that include, e.g., code, runtime, system tools, system libraries and settings for an application.

Further, computer 1102 can be enabled with a security module, such as a trusted processing module (TPM). For instance, with a TPM, boot components hash next in time boot components, and wait for a match of results to secured values, before loading a next boot component. This process can take place at any layer in the code execution stack of computer 1102, e.g., applied at the application execution level or at the operating system (OS) kernel level, thereby enabling security at any level of code execution.

A user can enter commands and information into the computer 1102 through one or more wired/wireless input devices, e.g., a keyboard 1138, a touch screen 1140, and a pointing device, such as a mouse 1142. Other input devices (not shown) can include a microphone, an infrared (IR) remote control, a radio frequency (RF) remote control, or other remote control, a joystick, a virtual reality controller and/or virtual reality headset, a game pad, a stylus pen, an image input device, e.g., camera(s), a gesture sensor input device, a vision movement sensor input device, an emotion or facial detection device, a biometric input device, e.g., fingerprint or iris scanner, or the like. These and other input devices are often connected to the processing unit 1104 through an input device interface 1144 that can be coupled to the system bus 1108, but can be connected by other interfaces, such as a parallel port, an IEEE 1394 serial port, a game port, a USB port, an IR interface, a BLUETOOTH® interface, etc.

A monitor 1146 or other type of display device can be also connected to the system bus 1108 via an interface, such as a video adapter 1148. In addition to the monitor 1146, a computer typically includes other peripheral output devices (not shown), such as speakers, printers, etc.

The computer 1102 can operate in a networked environment using logical connections via wired and/or wireless communications to one or more remote computers, such as a remote computer(s) 1150. The remote computer(s) 1150 can be a workstation, a server computer, a router, a personal computer, portable computer, microprocessor-based entertainment appliance, a peer device or other common network node, and typically includes many or all of the elements described relative to the computer 1102, although, for purposes of brevity, only a memory/storage device 1152 is illustrated. The logical connections depicted include wired/wireless connectivity to a local area network (LAN) 1154 and/or larger networks, e.g., a wide area network (WAN) 1156. Such LAN and WAN networking environments are commonplace in offices and companies, and facilitate enterprise-wide computer networks, such as intranets, all of which can connect to a global communications network, e.g., the Internet.

When used in a LAN networking environment, the computer 1102 can be connected to the local network 1154 through a wired and/or wireless communication network interface or adapter 1158. The adapter 1158 can facilitate wired or wireless communication to the LAN 1154, which can also include a wireless access point (AP) disposed thereon for communicating with the adapter 1158 in a wireless mode.

When used in a WAN networking environment, the computer 1102 can include a modem 1160 or can be connected to a communications server on the WAN 1156 via other means for establishing communications over the WAN 1156, such as by way of the Internet. The modem 1160, which can be internal or external and a wired or wireless device, can be connected to the system bus 1108 via the input device interface 1144. In a networked environment, program modules depicted relative to the computer 1102 or portions thereof, can be stored in the remote memory/storage device 1152. It will be appreciated that the network connections shown are examples, and other means of establishing a communications link between the computers can be used.

When used in either a LAN or WAN networking environment, the computer 1102 can access cloud storage systems or other network-based storage systems in addition to, or in place of, external storage devices 1116 as described above. Generally, a connection between the computer 1102 and a cloud storage system can be established over a LAN 1154 or WAN 1156 e.g., by the adapter 1158 or modem 1160, respectively. Upon connecting the computer 1102 to an associated cloud storage system, the external storage interface 1126 can, with the aid of the adapter 1158 and/or modem 1160, manage storage provided by the cloud storage system as it would other types of external storage. For instance, the external storage interface 1126 can be configured to provide access to cloud storage sources as if those sources were physically connected to the computer 1102.

The computer 1102 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, store shelf, etc.), and telephone. This can include Wireless Fidelity (Wi-Fi) and BLUETOOTH® wireless technologies. Thus, the communication can be a predefined structure as with a conventional network or simply an ad hoc communication between at least two devices.

### CONCLUSION

As it employed in the subject specification, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory in a single machine or multiple machines. Additionally, a processor can refer to an integrated circuit, a state machine, an application specific integrated circuit (ASIC), a digital signal processor (DSP), a programmable gate array (PGA) including a field programmable gate array (FPGA), a programmable logic controller (PLC), a complex programmable logic device (CPLD), a discrete gate or transistor logic, discrete hardware components, or any combination thereof designed to perform the functions described herein. Processors can exploit nano-scale architectures such as, but not limited to, molecular and quantum-dot based transistors, switches and gates, in order to optimize space usage or enhance performance of user equipment. A processor may also be implemented as a combination of computing processing units. One or more processors can be utilized in supporting a virtualized computing environment. The virtualized computing environment may support one or more virtual machines representing computers, servers, or other computing devices. In such virtualized virtual machines, components such as processors and storage devices may be virtualized or logically represented. For instance, when a processor executes instructions to perform “operations”, this could include the processor performing the operations directly and/or facilitating, directing, or cooperating with another device or component to perform the operations.

In the subject specification, terms such as “datastore,” data storage,” “database,” “cache,” and substantially any other information storage component relevant to operation and functionality of a component, refer to “memory components,” or entities embodied in a “memory” or components comprising the memory. It will be appreciated that the memory components, or computer-readable storage media, described herein can be either volatile memory or nonvolatile storage, or can include both volatile and nonvolatile storage. By way of illustration, and not limitation, nonvolatile storage can include ROM, programmable ROM (PROM), EPROM, EEPROM, or flash memory. Volatile memory can include RAM, which acts as external cache memory. By way of illustration and not limitation, RAM can be available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

The illustrated embodiments of the disclosure can be practiced in distributed computing environments where certain tasks are performed by remote processing devices that are linked through a communications network. In a distributed computing environment, program modules can be located in both local and remote memory storage devices.

The systems and processes described above can be embodied within hardware, such as a single integrated circuit (IC) chip, multiple ICs, an ASIC, or the like. Further, the order in which some or all of the process blocks appear in each process should not be deemed limiting. Rather, it should be understood that some of the process blocks can be executed in a variety of orders that are not all of which may be explicitly illustrated herein.

As used in this application, the terms “component,” “module,” “system,” “interface,” “cluster,” “server,” “node,” or the like are generally intended to refer to a computer-related entity, either hardware, a combination of hardware and software, software, or software in execution or an entity related to an operational machine with one or more specific functionalities. For example, a component can be, but is not limited to being, a process running on a processor, a processor, an object, an executable, a thread of execution, computer-executable instruction(s), a program, and/or a computer. By way of illustration, both an application running on a controller and the controller can be a component. One or more components may reside within a process and/or thread of execution and a component may be localized on one computer and/or distributed between two or more computers. As another example, an interface can include input/output (I/O) components as well as associated processor, application, and/or application programming interface (API) components.

Further, the various embodiments can be implemented as a method, apparatus, or article of manufacture using standard programming and/or engineering techniques to produce software, firmware, hardware, or any combination thereof to control a computer to implement one or more embodiments of the disclosed subject matter. An article of manufacture can encompass a computer program accessible from any computer-readable device or computer-readable storage/communications media. For example, computer readable storage media can include but are not limited to magnetic storage devices (e.g., hard disk, floppy disk, magnetic strips . . . ), optical discs (e.g., CD, DVD . . . ), smart cards, and flash memory devices (e.g., card, stick, key drive . . . ). Of course, those skilled in the art will recognize many modifications can be made to this configuration without departing from the scope or spirit of the various embodiments.

In addition, the word “example” or “exemplary” is used herein to mean serving as an example, instance, or illustration. Any embodiment or design described herein as “exemplary” is not necessarily to be construed as preferred or advantageous over other embodiments or designs. Rather, use of the word exemplary is intended to present concepts in a concrete fashion. As used in this application, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

What has been described above includes examples of the present specification. It is, of course, not possible to describe every conceivable combination of components or methods for purposes of describing the present specification, but one of ordinary skill in the art may recognize that many further combinations and permutations of the present specification are possible. Accordingly, the present specification is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A system, comprising:
at least one processor; and
at least one memory that stores executable instructions that, when executed by the at least one processor, facilitate performance of operations, comprising:
physically positioning the system, by the system, substantially above a device, wherein the device is configured to emit light-based communications substantially vertically, and wherein the device omits internet connectivity;
attempting to establish a light-based communications channel with the device to produce a result;
based on the result indicating success in establishing the light-based communications channel with the device, receiving data from the device via the light-based communications channel;
based on the result indicating failure in establishing the light-based communications channel with the device,
establishing a radiofrequency-based communications channel with the device, and
receiving the data from the device via the radiofrequency-based communications channel;
after receiving the data, physically moving the system, by the system, to a location where the system is configured to establish a network connection; and
backing up the data to a storage device via the network connection.

2. The system of claim 1, wherein the system comprises an aerial drone.

3. The system of claim 1, wherein the light-based communications channel comprises a Li-Fi connection.

4. The system of claim 1, wherein the radiofrequency-based communications channel comprises a Wi-Fi connection.

5. The system of claim 1, wherein physically positioning the system substantially above the device comprises establishing a line of sight between a first light-based communications component of the device and a second light-based communications component of the system.

6. The system of claim 1, wherein attempting to establish the light-based communications channel with the device comprises:
moving the system, by the system, while attempting to establish the light-based communications channel.

7. The system of claim 1, wherein receiving the data from the device via the light-based communications channel, or receiving the data from the device via the radiofrequency-based communications channel, is performed based on sending a request to the device for data transfer.

8. A method, comprising:
physically positioning a drone, by the drone comprising at least one processor, substantially above a device, wherein the device is configured to emit light-based communications substantially vertically, and wherein the device omits internet connectivity;
where establishing a light-based communications channel with the device is successful, receiving, by the drone, data from the device via the light-based communications channel;
where establishing the light-based communications channel with the device is unsuccessful, receiving, by the drone, the data from the device via a radiofrequency-based communications channel;
after receiving the data, physically moving the drone, by the drone, to a location where the drone is configured to establish a network connection; and
backing up, by the drone, the data to a storage device via the network connection.

9. The method of claim 8, wherein a cloud computing platform comprises the storage device.

10. The method of claim 8, wherein the location where the drone is configured to establish the network connection comprises a charging station for the drone.

11. The method of claim 8, wherein physically moving the drone to the location where the drone is configured to establish the network connection comprises:
while physically moving the drone toward a charging station, determining that it is possible to establish the network connection; and
initiating the backing up of the data while physically moving the drone toward the charging station.

12. The method of claim 8, wherein physically moving the drone to the location where the drone is configured to establish the network connection comprises:
while physically moving the drone toward a charging station, determining that it is possible to establish the network connection; and
based on determining that the drone lacks sufficient battery power to initiate the backing up of the data while physically moving the drone toward the charging station, refraining from initiating the backing up of the data while physically moving the drone toward the charging station.

13. The method of claim 12, further comprising:
after arriving at the charging station, initiating the backing up of the data.

14. The method of claim 8, wherein the data is first data, wherein the device stores a group of data that comprises the first data, and further comprising:
performing iterations of,
receiving respective parts of the group of data from the device,
backing up the respective parts of the group of data,
recharging at a charging station, and
returning to the device to perform another iteration after recharging.

15. A non-transitory computer-readable medium comprising instructions that, in response to execution, cause a system comprising at least one processor to perform operations, comprising:
in response to establishing a light-based communications channel with a device being determined to be successful, receiving data from the device via the light-based communications channel;
in response to establishing the light-based communications channel with the device being determined to be unsuccessful, receiving the data from the device via a radiofrequency-based communications channel;
after receiving the data, physically moving the system to a location where the system has been determined to be able to establish a network connection; and
backing up the data to computer storage via the network connection.

16. The non-transitory computer-readable medium of claim 15, wherein the operations further comprise:
physically positioning the system substantially above the device before attempting to establish the light-based communications channel with the device.

17. The non-transitory computer-readable medium of claim 15, wherein iterations of the receiving of the data, the physically moving of the system, and the backing up of the data are performed according to a schedule.

18. The non-transitory computer-readable medium of claim 17, wherein the schedule is determined based on user input data.

19. The non-transitory computer-readable medium of claim 15, wherein the operations further comprise:
while receiving the data from the device via the light-based communications channel, determining that the light-based communications channel has become unavailable; and
continuing to receive the data from the device via the radiofrequency-based communications channel.

20. The non-transitory computer-readable medium of claim 15, wherein the operations further comprise:
moving the device in a substantially circular motion while attempting to establish the light-based communications channel with the device.
